(19) United States
(12) Patent Application Publication
(10) Pub. No.: US 2025/0206062 A1
(43) Pub. Date: Jun. 26, 2025

(54) WHEEL COVER

(71) Applicant: KABUSHIKI KAISHA TOKAI-RIKA-DENKI-SEISAKUSHO, Niwa-gun (JP)

(72) Inventors: Keisuke MATOBA, Aichi (JP); Masahiro HONDA, Aichi (JP); Satoshi ITO, Aichi (JP)

(21) Appl. No.: 18/985,997

(22) Filed: Dec. 18, 2024

(30) Foreign Application Priority Data
Dec. 22, 2023 (JP) 2023-217395

(51) Int. Cl. B60B 7/08; B60B 7/02

(52) U.S. Cl. CPC B60B 7/08; B60B 7/02

(57) ABSTRACT

A wheel cover includes a wheel cover main body. The wheel cover also includes first engaging portions that project toward a wheel from the wheel cover main body and catch on the wheel by engaging with insertion portions provided in the wheel. The wheel cover also includes second engaging portions that project toward the wheel from parts of the wheel cover main body different from the parts provided with the first engaging portions and limit displacement of the wheel cover main body relative to the wheel by engaging with second spokes provided in the wheel.

### CROSS-REFERENCE TO RELATED APPLICATION

This application is based on and claims priority under 35 USC 119 from Japanese Patent Application No. 2023-217395, filed on Dec. 22, 2023, the disclosure of which is incorporated by reference herein.

### BACKGROUND

### Technical Field

The present disclosure relates to a wheel cover.

### Related Art

Japanese Patent Application Laid-open (JP-A) No. 2023-075763 discloses a wheel cover that attaches to a wheel. The wheel cover disclosed in JP-A No. 2023-075763 is configured to be attached to the wheel by inserting engaging portions provided on the wheel cover into mounting holes provided in the wheel. Here, each of the engaging portions includes a pair of engaging legs. One engaging leg is a first engaging leg that abuts against the peripheral edge portion of the mounting hole at a first angle relative to the insertion direction. The other engaging leg is a second engaging leg that abuts against the peripheral edge portion of the mounting hole at a second angle larger than the first angle relative to the insertion direction and energizes the first engaging leg toward the peripheral edge portion of the mounting hole. Because of this, rattling of the wheel cover relative to the wheel is inhibited.

In this connection, it is desired to be able to inhibit unwanted displacement such as fluttering of the wheel cover in association with rotation of the wheel and traveling wind, but the configuration described in JP-A No. 2023-075763 has room for improvement in this regard.

### SUMMARY

In consideration of the above circumstances, it is an object of the present disclosure to obtain a wheel cover that can inhibit unwanted displacement of the wheel cover in association with rotation of the wheel and traveling wind.

A wheel cover pertaining to a first aspect includes: a wheel cover main body; first engaging portions that project toward a wheel from the wheel cover main body and that catch on the wheel by engaging with first engaged portions provided at the wheel; and second engaging portions that project toward the wheel from parts of the wheel cover main body different from parts provided with the first engaging portions, and that limit displacement of the wheel cover main body relative to the wheel in a direction different from that of the first engaging portions by engaging with second engaged portions provided at the wheel.

A wheel cover pertaining to a second aspect is the wheel cover of the first aspect, wherein the wheel cover main body is urged toward the wheel as a result of the first engaging portions and the first engaged portions being engaged with each other in an axial direction of rotation of the wheel, and the second engaging portions engage with the second engaged portions in a circumferential direction of rotation of the wheel.

A wheel cover pertaining to a third aspect is the wheel cover of the first aspect or the second aspect, wherein the first engaging portions have main claw portions which, in a state in which the main claw portions are abutting against parts of the first engaged portions, limit displacement of the wheel cover main body toward an opposite side of the wheel, the second engaging portions have auxiliary claw portions which, when the wheel cover main body has become displaced in the axial direction of rotation of the wheel, abut against parts of the second engaged portions to limit displacement of the wheel cover main body toward the opposite side of the wheel, and a shape and a dimension of the second engaging portions are set so that the main claw portions disengage from the first engaged portions before the auxiliary claw portions abut against parts of the second engaged portions.

The wheel cover pertaining to the first aspect includes the wheel cover main body, the first engaging portions that project toward the wheel from the wheel cover main body, and the second engaging portions that project toward the wheel from parts of the wheel cover main body different from the parts provided with the first engaging portions. The first engaging portions catch on the wheel by engaging with the first engaged portions provided in the wheel. Furthermore, the second engaging portions limit displacement of the wheel cover main body relative to the wheel in a direction different from that of the first engaging portions by engaging with the second engaged portions provided in the wheel. With this configuration, unwanted displacement of the parts of the wheel cover main body provided with the second engaging portions, which are parts different from the parts provided with the first engaging portions, can be inhibited.

In the wheel cover pertaining to the second aspect, the wheel cover main body can be energized toward the wheel side as a result of the first engaging portions and the first engaged portions being engaged with each other in the axial direction of rotation of the wheel. Furthermore, unwanted displacement of the parts of the wheel cover main body provided with the second engaging portions can be inhibited as a result of the second engaging portions engaging with the second engaged portions in the circumferential direction of rotation of the wheel.

In the wheel cover pertaining to the third aspect, the main claw portions of the first engaging portions disengage from the first engaged portions of the wheel before the auxiliary claw portions of the second engaging portions abut against parts of the second engaged portions of the wheel. With this configuration, when detaching the wheel cover from the wheel, the auxiliary claw portions of the second engaging portions can be deterred from getting caught on parts of the second engaged portions.

### BRIEF DESCRIPTION OF THE DRAWINGS

An exemplary embodiment of the present disclosure will be described in detail based on the following figures, wherein:

FIG. 1 is a front elevation view showing a wheel cover;

FIG. 2 is a front elevation view showing a wheel;

FIG. 3 is a perspective view of the wheel cover as viewed from the opposite side of a design surface;

FIG. 4 is a perspective view of the wheel cover as viewed from the opposite side of the design surface and shows an enlargement of the outer peripheral portion of the wheel cover; and

FIG. 5 is a cross-sectional view showing a cross-section of part of the wheel cover and part of the wheel as cut along line 5-5 shown in FIG. 1 and FIG. 2.

### DETAILED DESCRIPTION

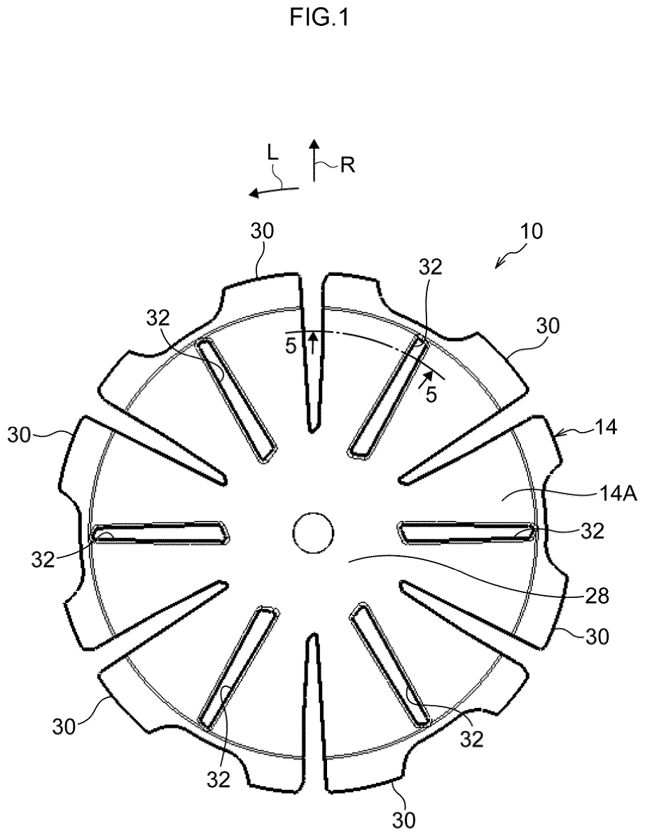

A wheel cover 10 pertaining to an embodiment of the present disclosure will now be described using FIG. 1 to FIG. 5.

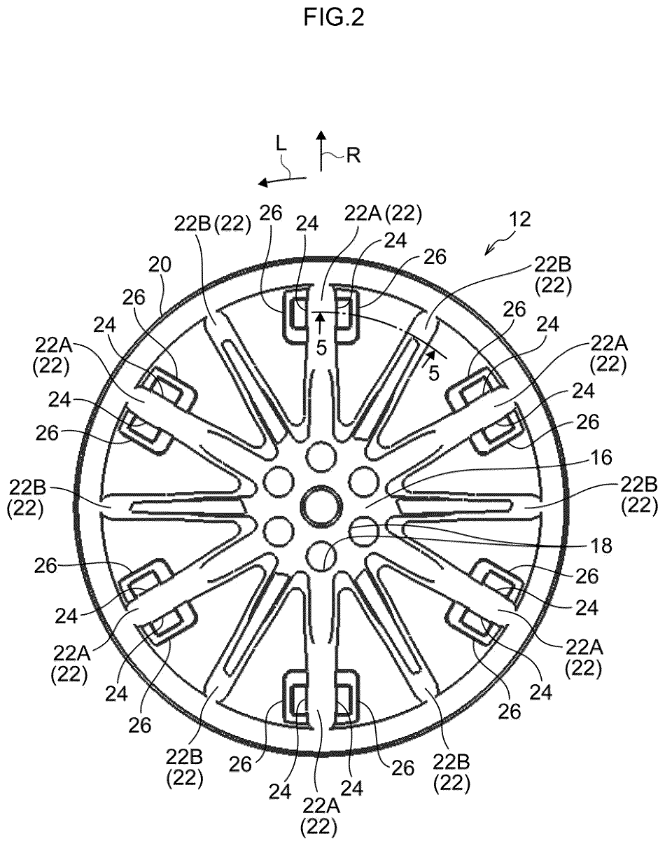

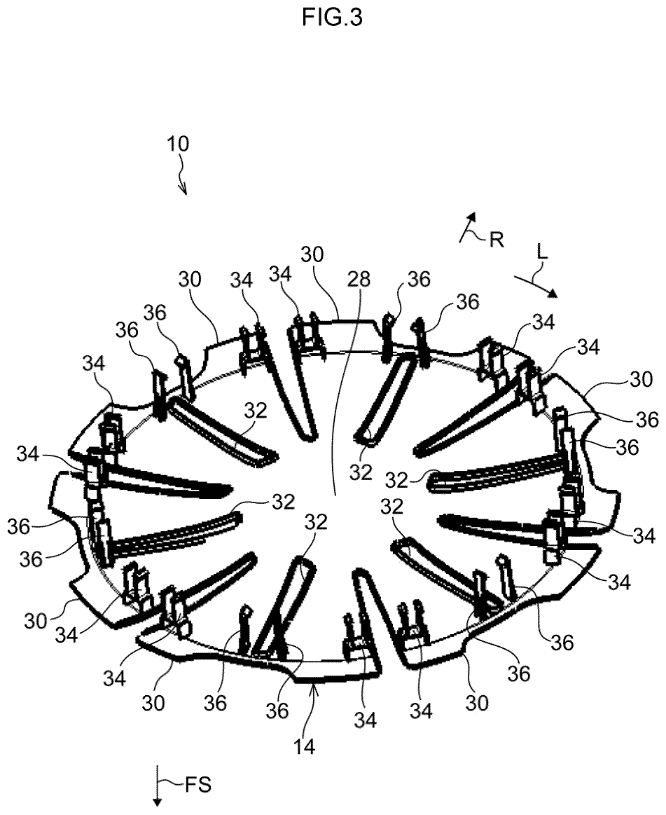

FIG. 1 and FIG. 3 show the wheel cover 10, and FIG. 2 shows a wheel 12 to which the wheel cover 10 attaches. It will be noted that in the drawings arrow FS indicates one side (a design surface side) in the axial direction of rotation of the wheel 12 and the wheel cover 10, arrow L indicates one side in the circumferential direction of rotation of the wheel 12 and the wheel cover 10, and arrow R indicates an outward direction in the radial direction of rotation of the wheel 12 and the wheel cover 10. It will be noted that in the following description the axial direction of rotation, the radial direction of rotation, and the circumferential direction of rotation of the wheel 12 and the wheel cover 10 are sometimes simply called the axial direction, the radial direction, and the circumferential direction, respectively.

As shown in FIG. 2, the wheel 12 is made of metal (e.g., aluminum alloy). The wheel 12 is rotatably supported by being secured to a hub of a vehicle. By attaching the wheel cover 10 (see FIG. 1 and other drawings) to the wheel 12, a defined range of the wheel 12 is covered from the vehicle width direction outer side by a wheel cover main body 14 of the wheel cover 10 described later. Here, the radial direction inner part of the wheel 12 is a center portion 16 that is secured to the hub. In the center portion 16 are formed plural bolt insertion holes 18 into which are inserted bolts for securing the wheel 12 to the hub. Furthermore, the radial direction outer part of the wheel 12 is a rim portion 20 to which a tire becomes attached. Moreover, between the center portion 16 and the rim portion 20 of the wheel 12 are provided plural spokes 22 that interconnect the center portion 16 and the rim portion 20. It will be noted that in the present embodiment twelve spokes 22 are provided, and these twelve spokes 22 are arranged at regular intervals along the circumferential direction of the wheel 12. Furthermore, on both circumferential direction sides of the radial direction outer parts of six spokes 22 of the twelve spokes 22 are formed rectangular portions 26 which, together with those six spokes 22, form insertion portions 24 serving as first engaged portions. Each of the insertion portions 24 is formed in the shape of a rectangular frame whose lengthwise direction coincides with the radial direction as viewed from the one side in the axial direction (the side of the direction of arrow FS) and has a configuration where both sides thereof in the axial direction are open. It will be noted that the spokes 22 that have the insertion portions 24 will be called first spokes 22A, while the spokes 22 that do not have the insertion portions 24 will be called second spokes 22B serving as second engaged portions. The first spokes 22A and the second spokes 22B are alternately arranged along the circumferential direction.

As shown in FIG. 1, the wheel cover 10 includes a wheel cover main body 14 that is made of resin and has a substantially disc-shaped outer shape. The one axial direction side of the wheel cover main body 14 is a design surface 14A. Furthermore, the radial direction inner part of the wheel cover main body 14 is a center portion cover portion 28 that covers the center portion 16 of the wheel 12 (see FIG. 2). Furthermore, the radial direction outer part of the wheel cover main body 14 is configured by plural outer peripheral extension portions 30 that extend outward in the radial direction from the center portion cover portion 28 and are spaced apart from each other in the circumferential direction. These plural outer peripheral extension portions 30 are each formed in a fan-like shape as viewed from the one side in the axial direction (the side of the direction of arrow FS) and are arranged at regular intervals along the circumferential direction. It will be noted that the wheel cover main body 14 of the present embodiment is provided with six outer peripheral extension portions 30. Furthermore, in the circumferential direction central portion of each of the six outer peripheral extension portions 30 is formed a decorative hole 32 that runs through that outer peripheral extension portion 30 in the axial direction. The shapes of the edges of these decorative holes 32 are rectangular shapes whose lengthwise direction coincides with the radial direction as viewed from the one side in the axial direction (the side of the direction of arrow FS).

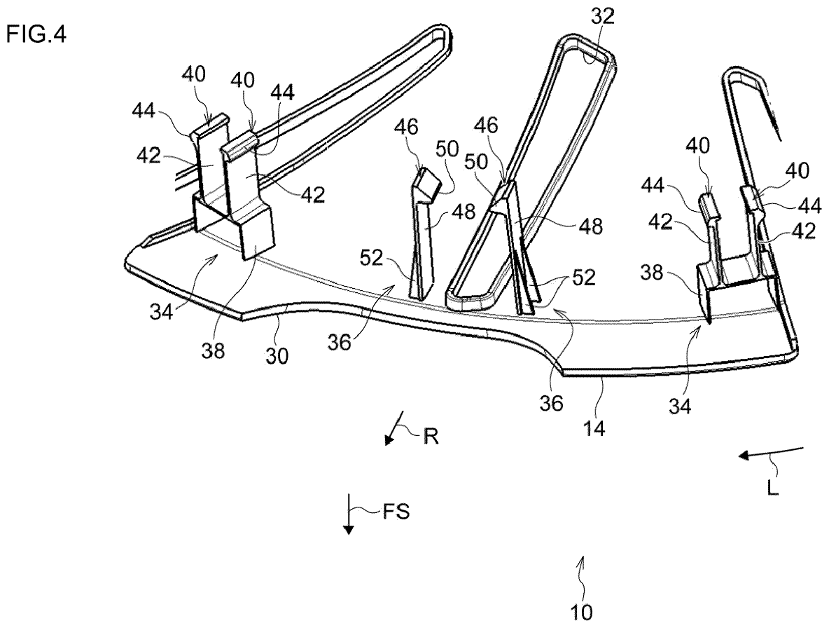

As shown in FIG. 3 and FIG. 4, the wheel cover 10 includes plural first engaging portions 34 that project toward the other side in the axial direction (toward the wheel 12) from the wheel cover main body 14. The wheel cover 10 also includes plural second engaging portions 36 that project toward the other side in the axial direction from the wheel cover main body 14. As shown in FIG. 3 to FIG. 5, the plural first engaging portions 34 engage with the plural insertion portions 24 of the wheel 12, and the plural second engaging portions 36 engage with the plural second spokes 22B of the wheel 12, whereby the wheel cover 10 becomes attached to the wheel 12, and a state in which the wheel cover 10 is attached to the wheel 12 is maintained.

Here, in the present embodiment, both circumferential direction sides of the radial direction outer part of each of the outer peripheral extension portions 30 are provided with a first engaging portion 34. That is, each outer peripheral extension portion 30 is provided with two first engaging portions 34. Furthermore, the circumferential direction central portion of the radial direction outer part of each of the plural outer peripheral extension portions 30 is provided with a pair of second engaging portions 36. That is, each outer peripheral extension portion 30 is provided with two second engaging portions 36. Furthermore, the two second engaging portions 36 provided on each of the outer peripheral extension portions 30 are disposed on both circumferential direction sides of the decorative hole 32 formed in that outer peripheral extension portion 30.

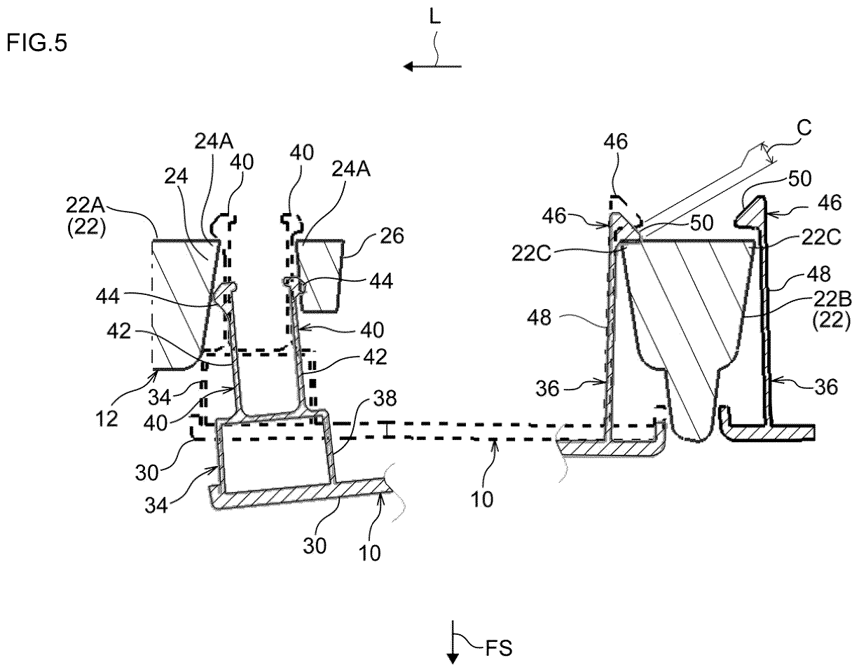

Specifically, as shown in FIG. 4 and FIG. 5, each of the first engaging portions 34 includes a base portion 38, which projects toward the other side in the axial direction from the outer peripheral extension portion 30, and a pair of engaging legs 40, which project toward the other side in the axial direction from the base portion 38 and are spaced apart from each other in the circumferential direction. The pair of engaging legs 40 are inclinable in directions toward and away from each other using the base portion 38 side as a center of inclination. It will be noted that an engaging spring not shown in the drawings is attached to the pair of engaging legs 40. Because of this, the pair of engaging legs 40 are energized in directions away from each other. Furthermore, the pair of engaging legs 40 may also be configured to project toward the other side in the axial direction from the outer peripheral extension portion 30 without the base portion 38 being provided.

Each of the engaging legs 40 includes a leg column 42, which projects toward the other side in the axial direction from the base portion 38, and a main claw portion 44, which projects in the circumferential direction from the end portion of the leg column 42 on the other side in the axial direction. The main claw portion 44 of the engaging leg 40 disposed on the one side in the circumferential direction among the pair of engaging legs 40 projects toward the one side in the circumferential direction relative to the leg column 42 of that engaging leg 40. Furthermore, the main claw portion 44 of the engaging leg 40 disposed on the other side in the circumferential direction among the pair of engaging legs 40 projects toward the other side in the circumferential direction relative to the leg column 42 of that engaging leg 40.

Each of the second engaging portions 36 includes an engaging leg 46 that projects toward the other side in the axial direction from the outer peripheral extension portion 30. The engaging legs 46 are inclinable in the circumferential direction using the outer peripheral extension portion 30 side as a center of inclination.

Each of the engaging legs 46 includes a leg column 48, which projects toward the other side in the axial direction from the outer peripheral extension portion 30, and an auxiliary claw portion 50, which projects in the circumferential direction from the end portion of the leg column 48 on the other side in the axial direction. Here, the auxiliary claw portion 50 of the engaging leg 46 of the second engaging portion 36 disposed on the one side in the circumferential direction among the two second engaging portions 36 provided on each outer peripheral extension portion 30 projects toward the other side in the circumferential direction relative to the leg column 48 of that engaging leg 46. Furthermore, the auxiliary claw portion 50 of the engaging leg 46 of the second engaging portion 36 disposed on the other side in the circumferential direction among the two second engaging portions 36 provided on each outer peripheral extension portion 30 projects toward the one side in the circumferential direction relative to the leg column 48 of that engaging leg 46. It will be noted that ribs 52 that project toward the one side in the circumferential direction are formed on the engaging leg 46 of the second engaging portion 36 disposed on the one side in the circumferential direction among the two second engaging portions 36 provided on each outer peripheral extension portion 30, and the parts of the ribs 52 on the one side in the axial direction are connected to the outer peripheral extension portion 30. Furthermore, ribs 52 that project toward the other side in the circumferential direction are formed on the engaging leg 46 of the second engaging portion 36 disposed on the other side in the circumferential direction among the two second engaging portions 36 provided on each outer peripheral extension portion 30, and the parts of the ribs 52 on the one side in the axial direction are connected to the outer peripheral extension portion 30.

### (Action and Effects of Present Embodiment)

Next, the action and effects of the present embodiment will be described.

As shown in FIG. 4 and FIG. 5, by causing the plural first engaging portions 34 to engage with the plural insertion portions 24 provided in the wheel 12 and causing the plural second engaging portions 36 to engage with the plural second spokes 22B provided in the wheel 12, the wheel cover 10 becomes attached to the wheel 12.

Specifically, when inserting the first engaging portions 34 into the insertion portions 24, the main claw portions 44 of the pairs of engaging legs 40 abut against inner peripheral surfaces of the insertion portions 24, and the pairs of engaging legs 40 bend (incline) in directions toward each other. When the first engaging portions 34 are pushed in toward the other side in the axial direction from this state, the main claw portions 44 of the pairs of engaging legs 40 ride over the insertion portions 24 and catch on end portions 24A of the insertion portions 24 on the other side in the axial direction. Here, in a state in which the main claw portions 44 of the pairs of engaging legs 40 are catching on the end portions 24A of the insertion portions 24 on the other side in the axial direction, energizing force toward the other side in the axial direction is input from the first engaging portions 34 to the outer peripheral extension portions 30.

Meanwhile, when the second engaging portions 36 become displaced toward the other side in the axial direction as the first engaging portions 34 are inserted into the insertion portions 24, the auxiliary claw portions 50 of the engaging legs 46 abut against side surfaces (surfaces on the one side in the circumferential direction or surfaces on the other side in the circumferential direction) of the second spokes 22B, and the engaging legs 46 bend (incline) in the opposite directions of the second spokes 22B. When the second engaging portions 36 become furthered displaced from this state toward the other side in the axial direction, the auxiliary claw portions 50 of the engaging legs 46 ride over the second spokes 22B and are disposed such that they overlap, in the axial direction, end portions 22C of the second spokes 22B on the other side in the axial direction. Here, in a state in which the wheel cover 10 is attached to the wheel 12 but the wheel 12 and the wheel cover 10 are not rotating (i.e., a state in which the vehicle is not traveling), the dimensions and such of the leg columns 48 of the engaging legs 46 in the axial direction are set so that a clearance with a distance C forms between the auxiliary claw portions 50 and the end portions 22C of the second spokes 22B on the other side in the axial direction.

Through the procedure described above, the wheel cover 10 is attached to the wheel 12, and a state in which the wheel cover 10 is attached to the wheel 12 is maintained.

Furthermore, in the wheel cover 10 of the present embodiment described above, by causing the main claw portions 44 of the pairs of engaging legs 40 of the first engaging portions 34 to catch on the end portions 24A of the insertion portions 24 on the other side in the axial direction, the parts of the wheel cover main body 14 provided with the first engaging portions 34 can be firmly supported on the wheel 12.

Furthermore, when the parts of the wheel cover main body 14 provided with the second engaging portions 36 become displaced outward in the vehicle width direction in association with the rotation of the wheels (the wheels 12 and the tires) and traveling wind, the auxiliary claw portions 50 of the engaging legs 46 of the second engaging portions 36 catch on the end portions 22C of the second spokes 22B on the other side in the axial direction. Because of this, the displacement of the parts of the wheel cover main body 14 provided with the second engaging portions 36 outward in the vehicle width direction can be limited. In this way, in the wheel cover 10 of the present embodiment, unwanted displacement of the wheel cover 10 associated with rotation of the wheels and traveling wind can be inhibited.

Here, when detaching the wheel cover 10 from the wheel 12, one causes the parts of the wheel cover main body 14 provided with the first engaging portions 34 to be displaced outward in the vehicle width direction (toward the one side in the axial direction) as indicated by the solid lines in FIG. 5. Because of this, the main claw portions 44 of the pairs of engaging legs 40 of the first engaging portions 34 disengage from the end portions 24A of the insertion portions 24 on the other side in the axial direction. Here, in the present embodiment, the aforementioned distance C is set so that the main claw portions 44 of the pairs of engaging legs 40 of the first engaging portions 34 disengage from the end portions 24A of the insertion portions 24 on the other side in the axial direction before the auxiliary claw portions 50 of the engaging legs 46 of the second engaging portions 36 abut against the end portions 22C of the second spokes 22B on the other side in the axial direction. Because of this, when detaching the wheel cover 10 from the wheel 12, the auxiliary claw portions 50 of the engaging legs 46 of the second engaging portions 36 can be deterred from getting caught on the end portions 22C of the second spokes 22B on the other side in the axial direction. As a result, workability when detaching the wheel cover 10 from the wheel 12 can be inhibited from being impaired.

It will be noted that although in the present embodiment an example was described where the main claw portions 44 of the pairs of engaging legs 40 of the first engaging portions 34 were configured to disengage from the end portions 24A of the insertion portions 24 on the other side in the axial direction before the auxiliary claw portions 50 of the engaging legs 46 of the second engaging portions 36 abut against the end portions 22C of the second spokes 22B on the other side in the axial direction, the present disclosure is not limited to this. Whether or not to set the claws in this way may be appropriately selected in consideration of workability when detaching the wheel cover 10 from the wheel 12.

Furthermore, the insertion portions 24 are not limited to the rectangular portions 26 and may have another configuration such as circular holes or grooves for example.

An embodiment of the present disclosure has been described above, but the present disclosure is not limited to what is described above and may be modified and implemented in various ways other than described above without departing from the spirit thereof.

What is claimed is:

1. A wheel cover, comprising:
a wheel cover main body;
first engaging portions that project toward a wheel from the wheel cover main body and that catch on the wheel by engaging with first engaged portions provided at the wheel; and
second engaging portions that project toward the wheel from parts of the wheel cover main body different from parts provided with the first engaging portions, and that limit displacement of the wheel cover main body relative to the wheel in a direction different from that of the first engaging portions by engaging with second engaged portions provided at the wheel.

2. The wheel cover of claim 1, wherein:
the wheel cover main body is urged toward the wheel as a result of the first engaging portions and the first engaged portions being engaged with each other in an axial direction of rotation of the wheel, and
the second engaging portions engage with the second engaged portions in a circumferential direction of rotation of the wheel.

3. The wheel cover of claim 1, wherein:
the first engaging portions have main claw portions which, in a state in which the main claw portions are abutting against parts of the first engaged portions, limit displacement of the wheel cover main body toward an opposite side of the wheel,
the second engaging portions have auxiliary claw portions which, when the wheel cover main body has become displaced in the axial direction of rotation of the wheel, abut against parts of the second engaged portions to limit displacement of the wheel cover main body toward the opposite side of the wheel, and
a shape and a dimension of the second engaging portions are set so that the main claw portions disengage from the first engaged portions before the auxiliary claw portions abut against parts of the second engaged portions.
